(19) United States
(12) Patent Application Publication
(10) Pub. No.: US 2005/0033649 A1
(43) Pub. Date: Feb. 10, 2005

(54) Premium drawing system

(75) Inventor: Kazuo Okada, Tokyo (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: Aruze Corporation, Tokyo (JP)

(21) Appl. No.: 10/497,532

(22) PCT Filed: Dec. 12, 2001
(86) PCT No.: PCT/JP01/10908

(51) Int. Cl. G06F 17/60

(52) U.S. Cl. 705/26

(57) ABSTRACT

A prize-lottery system 3 provides a prize offering lottery function to a qualified participant, by using a client terminal 2 connected to the Internet 1 as an input/output device. The prize-lottery system 3 is provided with a random number selection executing means for executing random number selection processing based on information received from the client terminal 2, and a winning mode notifying means for causing the client terminal 2 to display effect images constituting a story based on a winning mode determined as a result of the random number selection processing.

### TECHNICAL FIELD

The present invention relates to a prize-lottery system for implementing interactive prize (such as goods, money or other economic gain) offering lotteries with client terminals connected to the Internet.

### BACKGROUND ART

A lottery which undertakes to award a given prize to a winner (that is, a prize offering lottery) is one of widely used means for attracting customers and improving visibility. In the past, application means was practically limited to mail, and given application forms filled out as required were generally mailed to organizers or the like by an applicant (it is still the main way at present). Today, the Internet has been developed, and it is possible to access organizers' websites opened on the Internet for application.

In almost prize offering lotteries operated via the Internet today, however, the Internet has only replaced the existing mail as a means of application by applicants to organizers or the like. The prize offering lotteries do not seem to make full use of immediacy and interactivity of the Internet. Also, the lottery result notifying method is nothing but the notification of lottery results, adding no interest.

It is thus an object of the present invention to provide a prize-lottery system in which a result of the lottery can be instantly obtained and the notification of a result of the lottery can be enjoyed.

### DISCLOSURE OF THE INVENTION

The present invention has been made in view of the above problems, and proposes a prize-lottery system for providing a prize offering lottery function to a qualified participant, by using a client terminal connected to the Internet as an input/output device. The prize-lottery system includes the following functional means.

That is, the prize-lottery system includes (1) a random number selection executing means for executing random number selection processing based on information received from the client terminal; and (2) a winning mode notifying means for causing the client terminal to display effect images (either moving images or still images) constituting a story based on a winning mode determined as a result of the random number selection processing. The winning mode is a “Loss” or a “Win of some prize”. The winning mode may be “Win of an additional lottery right” in some system.)

According to the present invention, a winning mode determined as a result of random number selection processing is immediately given as effect images constituting a story on a display screen of the client terminal connected via the Internet. Thus, a lottery participant can instantly check a result of the lottery on his or her terminal (client terminal).

### BRIEF DESCRIPTION OF DRAWINGS

FIG. 1 is a schematic diagram of a network system of a prize-lottery system in the present invention;

FIG. 2 is a schematic diagram illustrating functions of a server;

FIG. 3 is a diagram illustrating a data structure stored in a personal information database;

FIG. 4 is a diagram illustrating an outline of execution sequence of a lottery operation;

FIG. 5 is a diagram illustrating a display image for use in receiving a lottery executive instruction by a qualified participant;

FIG. 6 is a diagram illustrating a display image for use in receiving an instruction of a selected moving direction of a lottery character by a qualified participant;

FIG. 7 is a diagram illustrating a prize selection accepting image;

FIG. 8 is a diagram illustrating a prize remaining number display image 1;

FIG. 9 is a diagram illustrating a prize remaining number display image 2;

FIG. 10 is a diagram illustrating a story development selection accepting image 1;

FIG. 11 is a diagram illustrating a story development selection accepting image 2;

FIG. 12 is a diagram illustrating li-zhi images in which a change in motion of a character is used;

FIG. 13 is a diagram illustrating li-zhi images in which a change in shape of a character is used;

FIG. 14 is a diagram illustrating a li-zhi image 1 in which a dedicated bar area is used;

FIG. 15 is a diagram illustrating a li-zhi image 2 in which a dedicated bar area is used;

FIG. 16 is a diagram illustrating a sponsor's advertisement image;

FIG. 17 is a diagram illustrating an exemplary prize advertisement image;

FIG. 18 is a diagram illustrating a full view of a virtual scene for use in the notification of a result of the lottery;

FIG. 19 is a diagram illustrating a story development prepared for each story and a probability of development and a winning probability at each stage;

FIG. 20 is a diagram illustrating a normal game initial image;

FIG. 21 is a diagram illustrating a story development when the loss of a normal game is decided;

FIG. 22 is a diagram illustrating a story development when the win of a normal game is decided;

FIG. 23 is a diagram illustrating four li-zhi images prepared for a “room fight scene”;

FIG. 24 is a diagram illustrating two representative li-zhi images prepared for an “upstairs fight scene”;

FIG. 25 is a diagram illustrating two representative li-zhi images prepared for a “corridor/toilet fight scene”; and

FIG. 26 is a diagram illustrating two representative li-zhi images prepared for an “outside fight scene”.

### BEST MODE FOR CARRYING OUT THE INVENTION

An embodiment of the present invention will be described below with reference to the accompanying drawings.

(A-1) Network System Configuration

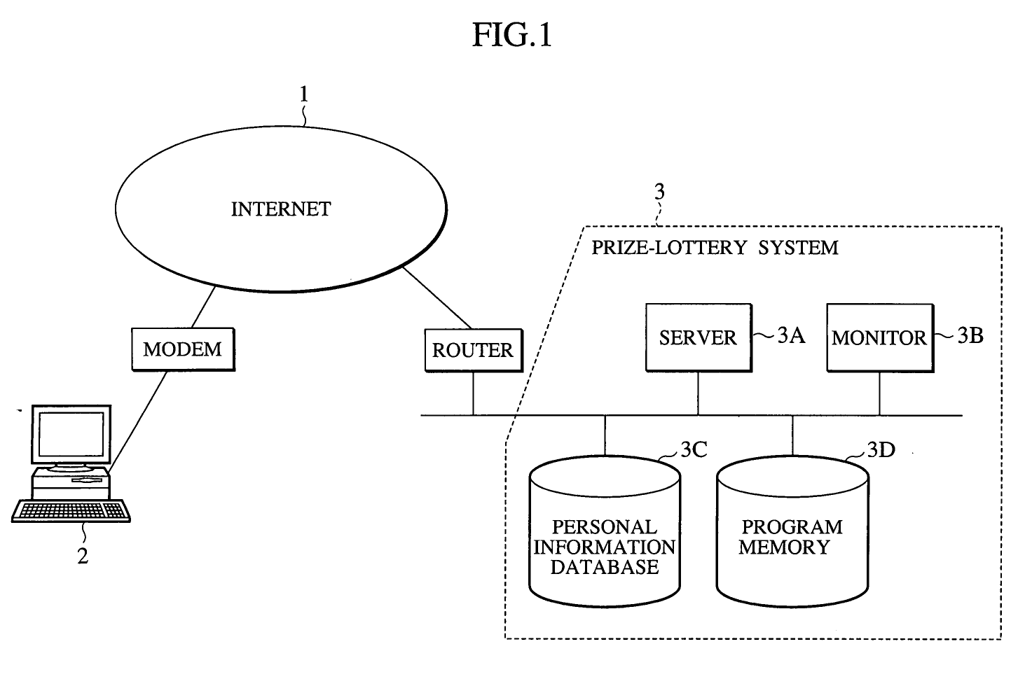

FIG. 1 shows an entire configuration of a network system according to this invention. As shown in FIG. 1, the network system includes, as basic elements, the Internet 1 as a communication medium, a client terminal 2 as an input/output device, and a lottery system 3 for executing a prize offering lottery. Although only a single client terminal 2 is illustrated in FIG. 1, it is for the simplification of description. To a practically operated system, a large number of client terminals are connected.

The client terminal 2 has at least a function of connecting to the Internet 1, a function of inputting instructions and the like, and a function of displaying a lottery process (from the start to the decision of a result).

As the client terminal, a computer terminal (including a display function), a game terminal with an Internet function, a mobile phone with an Internet function, a mobile information terminal with an Internet function, or a composite terminal of an Internet-dedicated terminal contained in a household appliance or the like and a display function (e.g., a television receiver) may be used. Hereinafter, they are referred to also as Internet terminals.

For the connection between the client terminal 2 and the Internet 1, a modem, a terminal adapter, a router or the like may be used. The connection between the client terminal 2 and the Internet 1 is not limited to a wire connection (such as a phone line, an ISDN line or a cable television line), and may be a wireless connection.

(A-2) Prize-Lottery System Configuration

The prize-lottery system 3 is configured with a server 3A, a monitor 3B, a personal information database 3C, a program memory 3D and other components, which are connected to one another via buses. A printer and an input device such as a keyboard, which are not shown in FIG. 1 showing the schematic configuration, are disposed when necessary.

Although FIG. 1 shows the configuration in which the prize-lottery system 3 is directly connected to the Internet 1 via a router, a firewall for protecting personal information and maintaining the fairness of the lottery is disposed at an appropriate location.

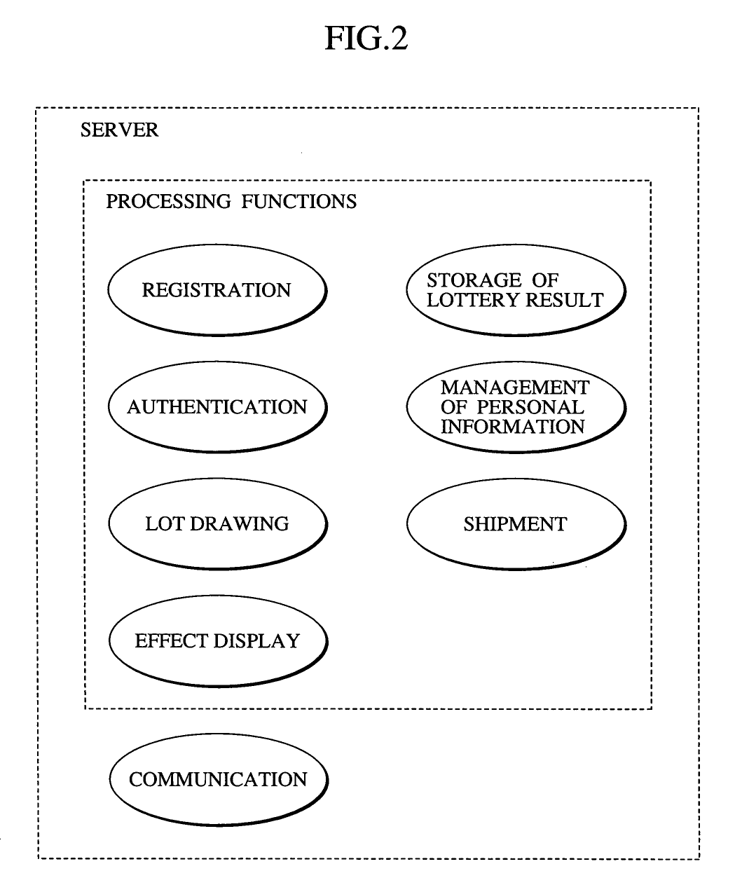

The server 3A is configured with a computer device with a server function. The server 3A is used for providing a series of functions required for the execution of the prize offering lottery (e.g., registration, authentication, lot drawing, effect display, storage of lottery results, management of personal information, shipment etc. as shown in FIG. 2). In place of the server 3A, it is also possible to prepare dedicated servers for different specific functions (or function groups) for load sharing.

The registration function is the function of registering qualified participants to enter the lottery in the personal information database 3C. The authentication function is the function of identifying participants by accessing the personal database 3C. In this embodiment, the authentication function decides whether a participant has certain qualifications for entry of the lottery or not.

The lot drawing function is the function of determining a winning mode by random number selection. A winning mode is in principle a “win (winning of some prize)” or a “loss”. However, it may be “winning of an additional lottery right”, depending on an operator's system design. The reason why a random number selection scheme is adopted for random number drawing is to guarantee fairness.

The effect display function is the function of notifying a lottery participant of a determined winning mode through effect images constituting a story. At that time, the client terminal 2 becomes an output device. In order to enable a lottery participant to enjoy effect images provided by the effect display function, it is desirable that the client terminal 2 has a relatively large display screen and a certain degree of communication speed.

However, when a mobile phone or the like constitutes a client terminal, it is likely that the display area, communication speed and so on are limited. Thus, the effect display function also includes the function of transmitting simplified images so as to enable a lottery participant to enjoy the lottery process under such limitations. This function allows the client terminal 2 to implement a pleasant execution even when there are limitations in display area, communication speed and so on.

The lottery result storage function is the function of storing the results of the lottery, that is, wins or losses in the personal information database 3C. Prize information includes information as to which prize is won, the time and date of the lottery and so on.

The personal information management function is the function of managing information on qualified participants (such as identification numbers, passwords, names, prize shipment locations, past histories and so on). The shipment function is the function of implementing arrangements for shipping prizes won. The shipment function manages whether shipment is done or not, the time and date of shipment and the like.

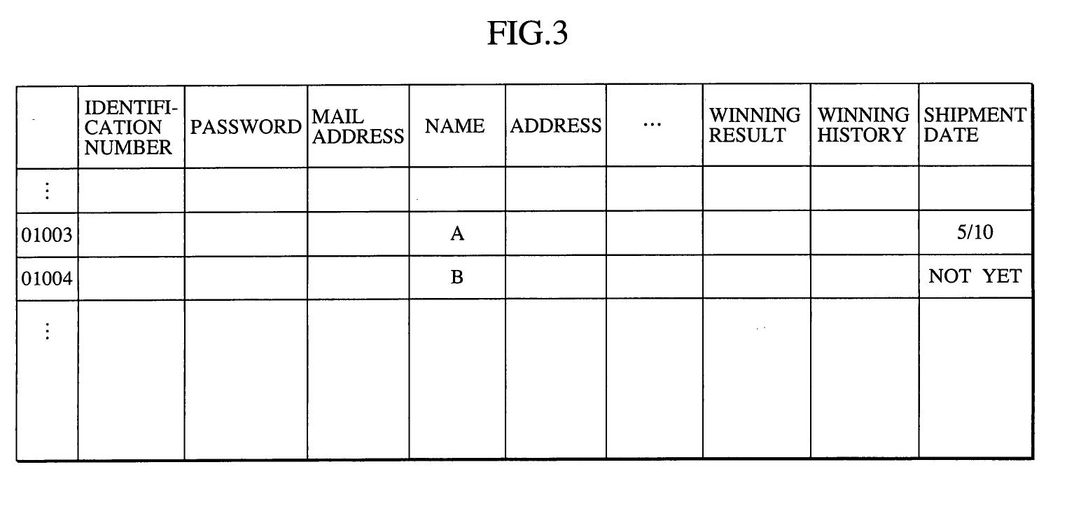

The monitor 3B is provided as a means for monitoring the progress of lottery processing and the like. The personal information database 3C is, as shown in FIG. 3, a memory means for storing identification numbers, passwords, names, addresses, lottery results, past histories, whether shipment is done or not and the like. The program memory 3D is a memory means for storing programs such as a lottery program and effect programs, data files required for the execution of the programs, and the like. Specifically, the memory means is implemented by a hard disk, a readable/writable optical disk or the like.

(A-3) Provision of Prize Offering Lottery Function

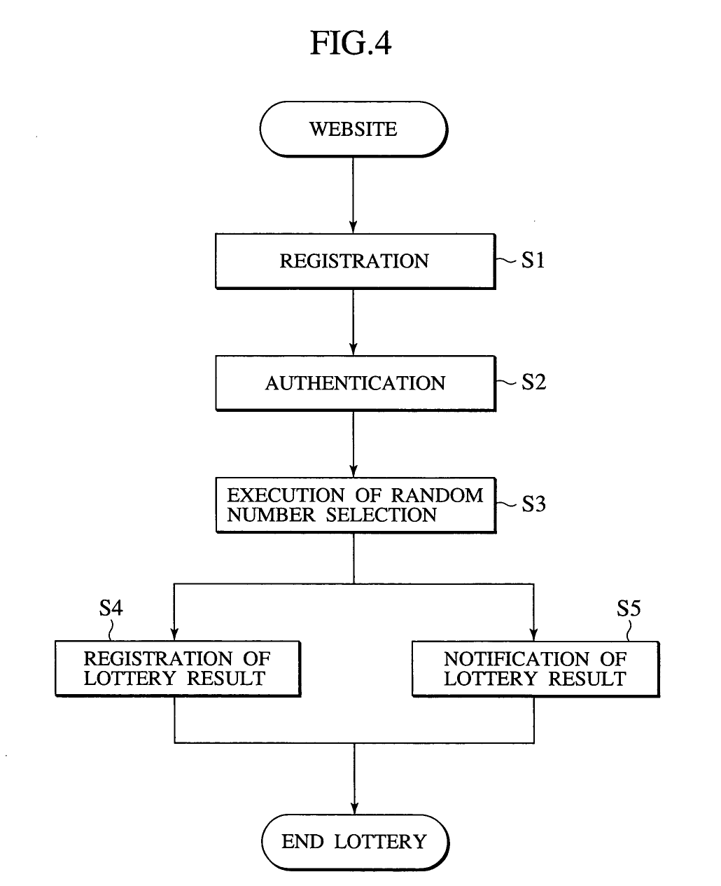

As a method of providing a prize offering lottery service, a variety of forms (charge-free, charged, exclusive and the like) are possible according to the objects, strategies and the like of operations considered by operators, which do not share all details in execution sequence and execution contents. However, it is impractical to individually describe all the contents of operations unique to those systems. Thus, in this embodiment, description will be made on an exemplary basic execution sequence which will be adopted in a lottery service of this kind. FIG. 4 illustrates the outline of the execution sequence.

Display of prizes to be awarded for wins is provided on a website of the operator running the lottery.

(a) Registration of Qualified Participant

When a qualified participant to the virtual lottery enters the lottery for the first time, processing for registering personal information on the applicant is initially executed (step S1). For example, a mail address, identification number (ID), password, name, address, location to which a prize for a win is shipped, and so on, are registered. The personal information entered through the client terminal 2 by the qualified participant is registered in the personal information database 3C via the server 3A.

(b) Authentication Operation

On the other hand, when a qualified participant has ever entered the lottery or has ever entered another lottery operated on the same website, processing for authenticating the participant is executed (step S2). For the authentication, the prize-lottery system 3 requires the qualified participant to input the “mail address and password” or “ID and password”.

When information corresponding to the input information has been registered in the personal information database 3C, the prize-lottery system 3 notifies the qualified participant of the result of the authentication (such as the participant's name), and moves to a lottery execution stage.

Input of authentication information may be required each time a qualified participant enters the lottery, or may be done by using an automatic transmission function of the client terminal 2.

In a case where the lottery is opened only to people meeting a given condition, it is also checked whether an applicant has qualifications for entry or not. For example, when everyone can enter the lottery but is limited in the number of times he or she can enter, it is determined whether the number of times of entry into the lottery meets a given condition.

In another case where a questionnaire or an application to a prize-offered advertisement is a condition, it is determined whether there is an input of necessary information or not. In still another case where it is opened only to purchasers of a given product, it is determined whether information used for entry attached to a product or the like (an ID number or the like) is right or wrong.

In still another case where an entry into a lottery is charged, it is determined whether an entry fee can be paid or not. For example, it is determined whether an applicant has an account to which the entry fee can be charged (the account becomes the destination of transfer of prize money in a certain case), or whether the entry fee has already been collected (when the entry fee for the lottery is included in a selling price of some kind of software, for example, it is determined whether a qualified participant is the user of the software and whether a necessary amount of money for the entry into the lottery is left in the personal information database 3C of the user.

In this connection, in a possible method, an entry right to enter the lottery can be purchased at a convenience store or the like, and information becoming effective by the purchase is entered through a client terminal to be permitted the entry into the lottery. It is also possible to adopt a method in which the entry fee is collected from an advertising company. Another method of charging the entry fee as a part of communication expenses may also be possible.

(c) Lottery Operation

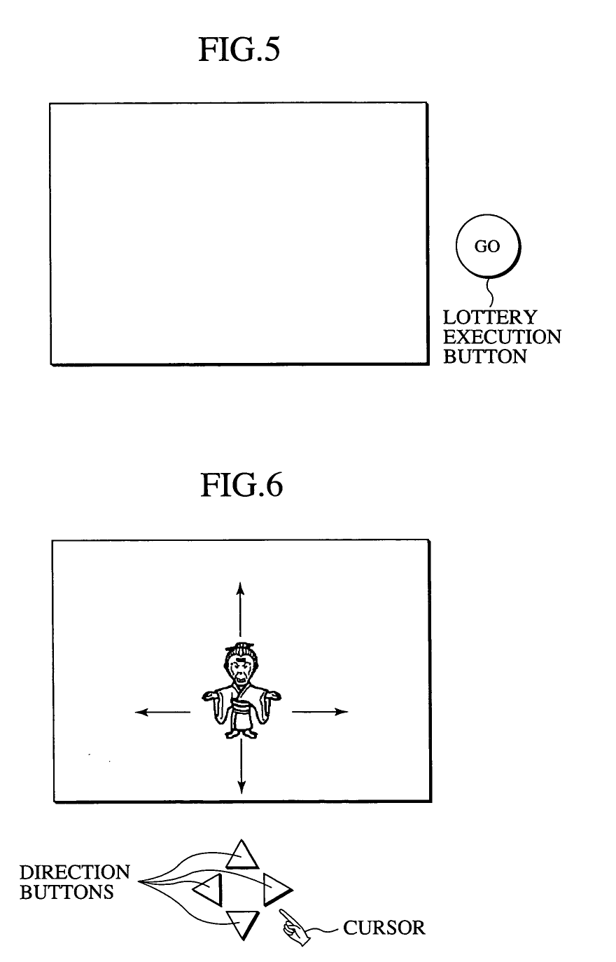

When the predetermined authentication operation is completed, the prize-lottery system 3 executes random number selection according to the lottery program (step S3). Random number selection may be executed automatically or may be executed based on a predetermined lottery execution operation done by a qualified participant (e.g., clicking a lottery execution button on a screen as shown in FIG. 5).

The random number selection is performed by checking a winning probability table for a random number value selected from among random number values generated by a random number generation means (e.g., a sampling circuit). The winning probability table stores data which associates selected random number values with the respective winning modes.

A result of a lower frequency of appearance (lower probability) is generally allocated a more valuable prize, though the way of allocating prizes is not limited thereto.

Normally, a single lottery operation determines a winning mode. That is, it determines a win or loss, and also determines which prize is won for a win. When the winning mode is determined, an effect program and a data file corresponding to the determined winning mode are read, and the lottery participant is notified of the winning mode. The details will be described below.

Generally, for a valuable prize, an effect display of a low frequency of appearance is selected, and for a relatively low-cost prize, an effect display of a high frequency of appearance is selected. This enables the participant to have not only a sense of superiority that he or she has won a valuable prize but also a sense of achievement that he or she was able to see an effect display of a low frequency of appearance at the same time.

In the case of a lose, an effect display of a high frequency of appearance is often selected. However, an effect display of a high frequency of appearance is not necessarily always selected, and an effect display of a low frequency of appearance can be selected. Thus, even upon a lose, an effect display of a low frequency of appearance can be selected so that the lottery participant can fully enjoy the process before a result of the lottery is decided.

Specifically, the participant can see a story development of effect images, anticipating winning a valuable prize. At the same time, it is possible to cause the participant to have a feeling of making another try because he or she might have almost won.

The above is the basic random number selection execution function. However, depending on the operation strategy of an operator, there is a case where a single random number selection does not determine a win or loss, and an additional lottery right is given. The additional lottery right is different from a second lottery, and is a conditional lottery right included in the ongoing lottery operation. In the description, such a lottery is referred to as an additional lottery or an additional lottery right. The additional lottery function can be used for providing a chance of winning a valuable prize.

A lottery participant may be or may not be notified of the fact that an additional lottery will be done. In the case where a lottery participant is not notified of the fact, the server 3A automatically executes an additional lottery. The number of possible occurrences of additional lotteries is set by an operator.

In the case where a lottery participant is notified of an additional lottery, in a possible method, a lottery execution button is displayed on the screen seen by the lottery participant at a scene where a story development of effect images to be described below comes to the end of the first stage for click operation, or a simple game is provided so that a lottery is executed based on the result, or it is linked to the selection of a moving direction of a character appearing in an effect image.

As an input means for instructing a character's moving direction, a method of using an input image as shown in FIG. 6, for example, is possible. Alternatively, independently of these selection operations, the random number selection may be executed by the server 3A automatically.

Incidentally, when a prize corresponding to a result of random number selection is not left (the prize has already been won a predetermined number of times set by the operator), and when the prize to be delivered to the lottery participant cannot be delivered, a method of immediately executing a second random number selection to determine a winning mode may be adopted, or it may be determined as win of a prize lower by one rank than the original winning prize (if that prize has also already been won a predetermined number of times, a prize lower by one more rank). The provision of such a function can prevent such a situation that after notification to a lottery participant, it is found that the prize to be delivered is out of stock.

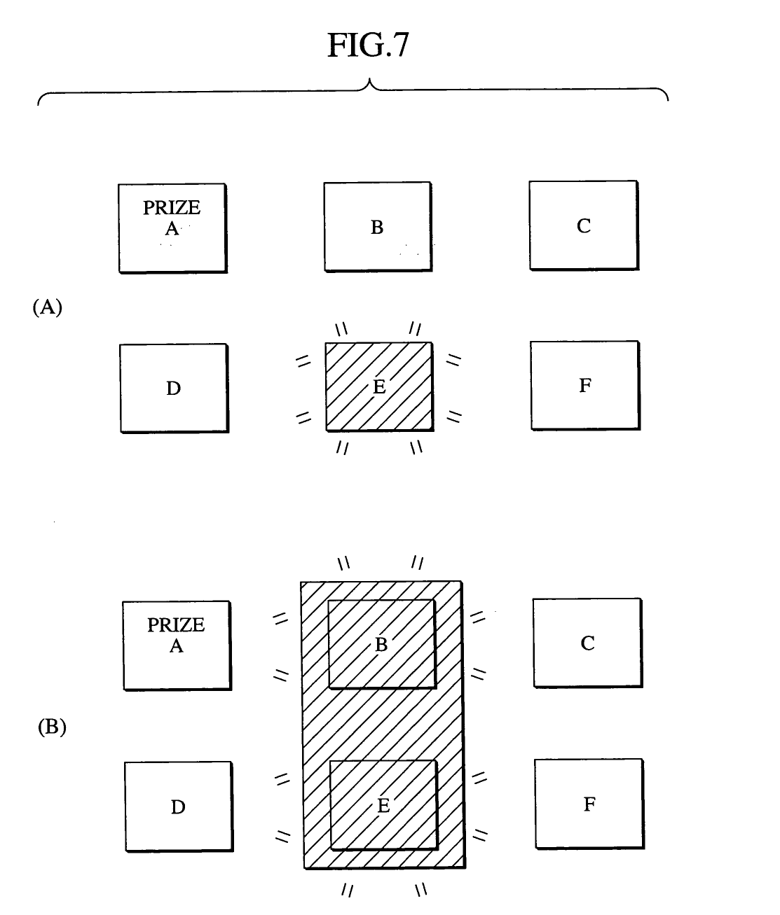

In the above, a lottery participant has no right to select a prize and a prize is uniquely determined based on a result of random number selection, and a lottery participant has no right of selection. Alternatively, as shown in FIGS. 7(A) and 7(B), it is also possible to let a participant to select one or more prizes he or she wants before the execution of random number selection. In this case, a image for selecting a prize before the execution of random number selection is displayed, so that a lottery participant can also specify only a prize he or she wants for a win for the lottery.

When a prize only meets a particular taste, many people do not want such a prize other than that they want. Some of prize collectors want to get a prize they do not have. Such needs would not be small.

It is also possible to fix an order of priority in prize selection, so that when a higher priority prize is won but the prize has already been won a predetermined number of times, a prize directly below in priority is selected as a win for the notification of the result of the lottery.

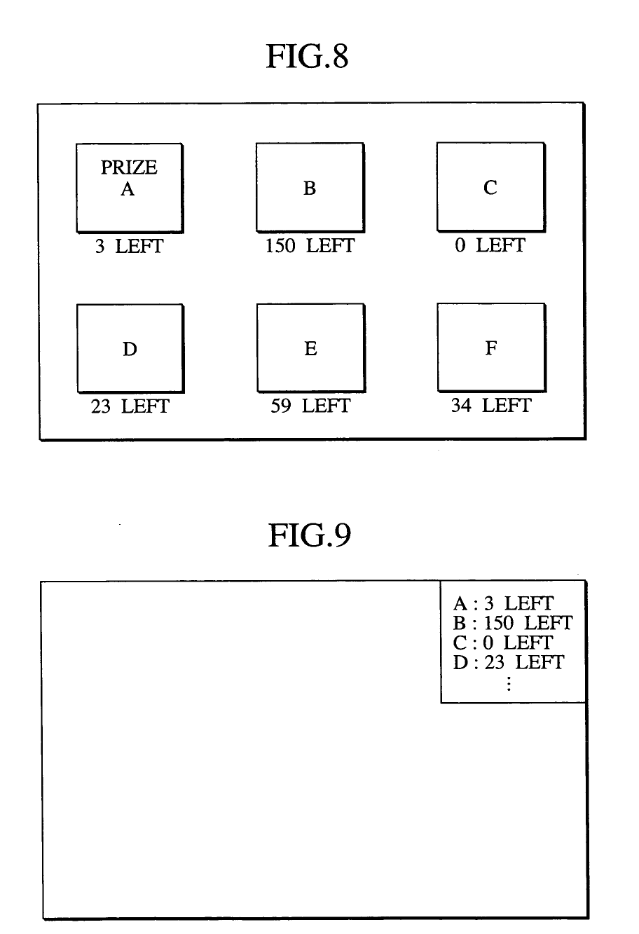

When such prize selection is enabled, a lottery participant has a great interest in the remaining amounts of prizes to be offered. Thus, a function of displaying prizes (in photographs or pictures) and the remaining amounts on the entire screen as shown in FIG. 8, or a function of displaying the names of prizes and the remaining amounts on a part of the screen as shown in FIG. 9, may be provided to implement a more user-friendly lottery system.

Such display allows a qualified participant to foresee a result. Therefore, the participants can enter the lottery with conviction. Such display enables a change of selection to a prize of a higher winning probability. As a result, a user-friendly lottery system capable of reflecting a qualified participant's will more in the lottery operation. Is implemented.

In the above-described example, description has been made with winning probabilities basically fixed. Alternatively, referring to participation histories stored in the personal information database 3C, processing to increase a winning probability for a person who has entered a large number of times or to increase a winning probability for a person having little winning experience may be performed according to setting by an operator.

Especially when the lottery system is offered upon payment, such a function can benefit a lottery participant and can be an incentive for the participant to enter the lottery. In such a case, it is also possible to fix winning probability for fairness, and to perform adjustments by increasing lottery opportunities (offering lottery rights free of charge), offering free prizes or the like.

It is also possible to provide a scheme enabling changing winning probability or the kinds of prizes (including additional free prizes) or the like arbitrarily by a lottery operator. For example, it is also possible to set a winning probability relatively higher in a courtesy campaign than in other cases.

For example, the courtesy campaign may be conditional in time such as one provided for a limited period of time or one provided only in a season, or conditional in location such as one provided in a limited location, or conditional in the number of entries such as one accepting the first some people, some people weekly, or some people monthly, or conditional in things such as one accepting purchasers of specific goods (to mark out them from other target goods with lottery rights). It is also a possible method to change winning probability according to the total amount of purchase of (all or part of or individual) target goods registered with respect to each lottery participant.

It is also possible to provide a scheme enabling changing winning probability or the kinds of prizes (including additional free prizes) or the like, according to information on a lottery participant normally unrelated to the lottery. For example, winning probability or the like may be changed according to the fact that a character (such as a main character) has got a specific item in a game played before the lottery, or the fact that the value of an ability count (such as an experience count or a power count) of a character has reached a predetermined value in a game played before the lottery, or the fact that a hidden character has been discovered in a game played before the lottery, or the fact that a bonus stage in a game consisting of a plurality of stages is cleared, or the fact that the score of a game exceeds some points, or the like.

A game may be one played independently of a lottery to which a lottery participant can enter on a website of a lottery operator (entry is made at the will of a lottery participant), or may be one played in the internet terminal 2. In the latter case, a game is not necessarily limited to one played in the internet terminal 2, and all that needs to be done is that the history and the result of a game played in a dedicated game terminal or the like is read into or is ready to be read into the internet terminal 2 before the execution of a lottery.

(d) Winning Mode Registration

When the lottery operation is executed to determine the presence or absence of a win, the sever 3A registers the determined result in the personal information database 3C, so as to make it available for management thereafter (step S4). For example, the time and date when the lottery participant enters the lottery, the presence or absence of a win or loss, a winning prize for a win and so on are registered. The registered information is used for the shipment of the prize to be described below.

The number of entries into the lottery or a winning history may be reflected in qualifications to enter subsequent lotteries. For example, it is possible to disqualify a participant having entered a predetermined number of times from entering the lottery, or to increase the number of times a participant having entered a predetermined number of times can enter the lottery. The registration information can also be used in processing to increase winning probability for a participant having always been losing without winning history (e.g., in a lottery unit or in a certain period of time) so that the participant is likely to win.

When a winning prize is various in color or a printed character is various in design, and when a lottery participant can select one of the different colors or the different designs at will, it is also possible at the registration to prompt the participant to select a desired prize via the client terminal 2 and to register the prize of the finally selected color or design.

The selection may be made not only after a win is decided, but also before the execution of random number selection, or at the stage where a win is not decided after the execution of random number selection (e.g., at the stage before the execution of a possible additional drawing).

The provision of the interactive selection function can further increase willingness to enter into the lottery as compared with the case where a prize cannot be selected. Further, it is possible to target only a really desired prize, which satisfies the need of a lottery participant who is particular about a minute difference in prize design.

(e) Notification via Effect Images

Concurrently with the above-described winning mode registration operation, a winning mode notification operation is executed (step S5). For the notification, effect images constituting a story corresponding to a winning mode are used. Functions involved in the notification operation will be described below.

<Effect Function>

The prize-lottery system uses effect images constituting a story for the notification of a winning mode. This is for making a process before provision of a result of the lottery more enjoyable than in a conventional method of notifying a lottery participant of a result only or immediately.

A result of the lottery is only a win or loss, and the result of the lottery is quickly decided. The current scheme of directly notifying a participant of a lottery result using the Internet lacks spice, and is just for checking whether a prize is won or not. Thus, both a participant and an operator or sponsor do not make full use of the rare chance of meeting.

Thus proposed is a method of combining the notification of a winning mode with effect images constituting a story to enable a lottery participant to enjoy a story development displayed on the screen. That is, the method allows a lottery participant to superimpose the story development on his or her luck to enjoy fluctuation between hope and despair in the process of notification.

Suppose that effect images constituting a story are provided through a role-playing game. For example, a story development is prepared in which a main character in an imaginary story fights against an enemy on a stage set on the image, and when the character conquers the enemy, a prize is won, and when the character is defeated by the enemy, no prize is won. Provision of effect images constituting a story is not limited to the roll-playing game scheme.

The link between the activity of the main character in a story and a prize can create an illusion that the lottery operation proceeds in real time, so as to provide the fun of leaving win to the activity of the main character.

If the above-described example of the roll-playing game is set to provide a more valuable prize as the main character defeats a larger number of enemies to finally survive the fight (the efforts of the main character are greater) (the effect images are images of a lower frequency of appearance, that is, of lower probability), a story development (in which enemies are defeated) and an increased chance of getting a valuable prize provide a more enjoyable notification through effect images.

If the main character is finally defeated by an enemy, no matter how many enemies the main character has beaten, the result is a “loss”. However, many of lottery participants can feel that a valuable prize was almost won, instead of just finding the loss. Thus it is possible to create meaning to the lottery and provide a certain kind of satisfaction.

Alternatively, the game may be used to award a prize or to give a second lottery right (another lottery), according to the number of enemies or the type of an enemy the main character has defeated before being finally defeated.

Incidentally, concerning a connection between a winning mode and provided effect images, it is the simplest method to provide a story development corresponding to a random number value selected as a result of random number selection. That is, a story development corresponding to a random number value is provided, and if the random number value corresponds to a win, the development is ended with a winning image, and if the random number value corresponds to a loss, the development is ended with a losing image. In the case of a loss, it is also possible to only select a story development so as to provide unpredictability of story development.

<Main Character Selection Function>

It is also possible to prepare multiple main characters to appear in a story so that a participant can select one of them to enjoy seeing how a selected main character acts. In this case, it is possible to cause the participant to have a feeling that he or she is actively involved in the lottery, resulting in a strong sense of achievement when he or she wins.

In this connection, various methods are possible, in which random number selection is independent of the selection of a main character, winning probability is slightly changed, and a prize of a high winning probability is changed and so on.

If the different abilities, arms and the like of different main characters are displayed on the screen so that a participant can select a main character based on the information, it is possible to further increase lottery participants' willingness to enter the lottery.

<Story Development Selection Function>

If a number of story developments are prepared, a lottery participant can encounter a different story development in each lottery, so that the participant can be looking forward to a story development provided by entering the lottery, thinking of “What are other story developments like?” or “What kind of ending is prepared after this scene?”. Thus, in addition to the result of the lottery, the process of notification of the lottery result can be of interest.

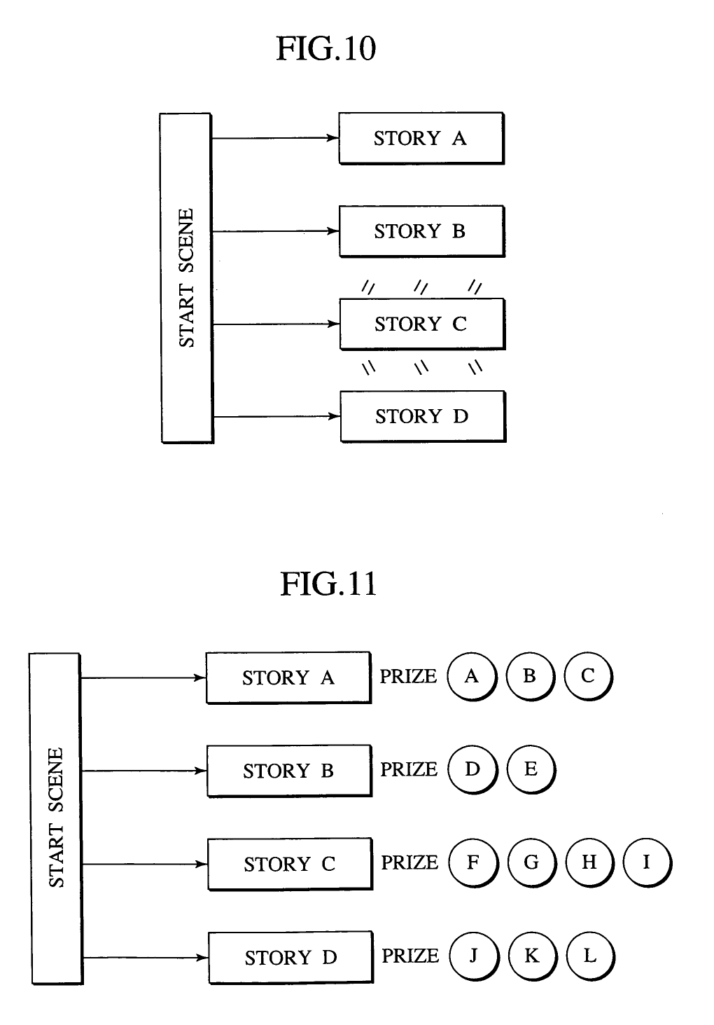

As shown in FIG. 10, it is also possible to display the kinds of story developments prepared by an operator on the screen before the execution of a lottery so that a lottery participant can select one of the story developments.

The provision of this function allows a participant to enjoy both an entry into a lottery and a story development, thinking like “this time I will see Story B because I saw Story A last time”, “I will try Story C this time also because Story C tried last time was interesting”, or “a friend won Prize X in Story D, so I will select Story D”.

With respect to the lottery operation in the case where the above selection is possible, the lottery operation may be unique to a selected story development. In that case, individual winning probability may be set for each story development. For example, it is possible to set winning probability of development A higher than that of development B which provides a more valuable prize.

On the other hand, the lottery operation may be independent of a selected story development so that selection of any story development leads to win of the same prize with the same winning probability. In this case, it is also possible to associate different prizes with different story developments.

It is also possible that the server 3A arbitrarily determines the story development when a lottery participant especially has no desire while the selection of a story development is possible. The effect images viewed by the lottery participant in this case are the same. However, the effect images are different in meaning between the case where the story development is determined based on the result of random number selection and then its notification is performed (a lottery is executed under the state where there is a possibility of winning one of all prizes) and the case where the story development is determined to specify a prize to win and then random number selection is performed.

Each story development may be allocated a single prize or multiple prizes. It is also possible to allocate different numbers of or different kinds of prizes to different story developments.

As shown in FIG. 11, it is also possible to display connections between story developments and the corresponding prizes in a list to be used for reference when selecting a story development.

Such display allows a lottery participant to fully make sense of the selection of a story development in making the selection. Thus, a more user-friendly prize offering lottery can be provided than before.

<Character Moving Function>

Interactivity of the Internet is utilized to enable directly determining the moving direction of a main character, so that a lottery participant can feel active participation in a lottery and have increased fun other than a result of the lottery.

This function can be used in the above-described story selection and can increase the degree of freedom in effect contents such as the discovery of a hidden character buried in the image and the selection of an opponent.

When the story is developed by the movement of the character in a direction determined by the participant, the lottery result can be strongly identified with the selection.

It is also possible to prevent the selection of movement of the character by the lottery participant from influencing a winning mode determined by the execution of the lottery operation independently of the movement of the character. On the other hand, it is also possible to re-execute the lottery operation or change winning probability, depending on the direction of movement of the character.

<Li-zhi Image Function>

A combination of the above-described various functions can provide more diversified amusing effect images for use in the notification of a winning mode. Preparation of a li-zhi image function for indicating that the winning probability is further increased (a special mode image display function) can make the notification of a lottery result more amusing. For example, the following special mode images are prepared:

(1) A Scene to be Displayed only when the Winning Probability is High is Prepared.

For example, a story development is provided with a depth (several images are prepared) so that when the winning probability is increased, a scene at that time is switched to the next scene. A participant seeing the switching of the scenes can find the fact that the winning probability is increased.

For increased amusement, it is also possible to prepare a win and loss of a prize at each scene according to the depth of the scene (the frequency of appearance or the order of appearance), so that when neither of them is drawn, the scene is switched to the next scene where a more valuable prize can be got.

Needless to say, it is arbitrary whether to prepare wins and losses for all scenes. There may be a scene only with an effect image associated with no prize win regardless of expectations of a participant.

(2) A Main Character is Caused to Make a Specific Movement.

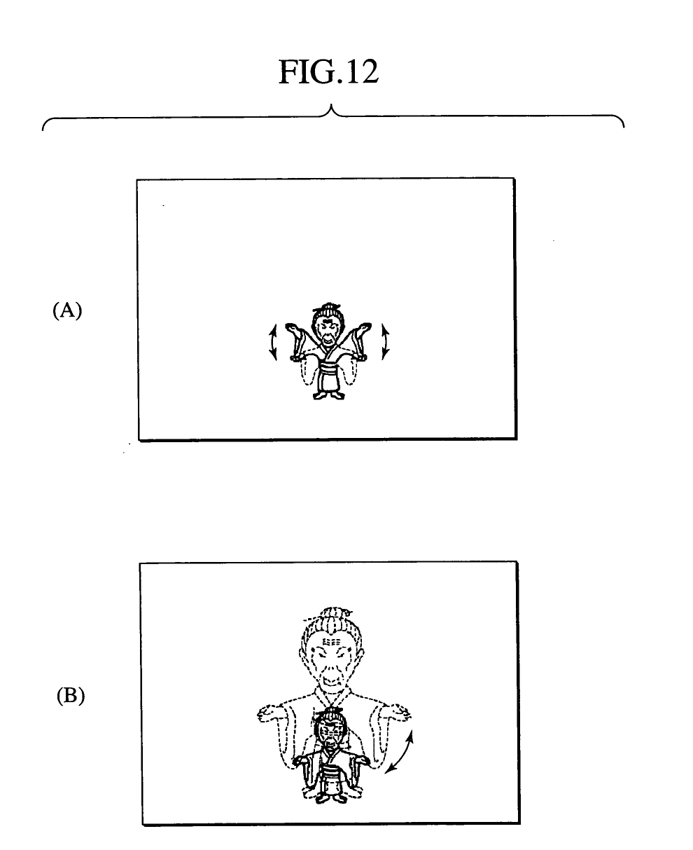

As shown in FIG. 12(A), for example, a character is caused to move her arms up and down repeatedly, or, as shown in FIG. 12(B), the main character is made larger or smaller in size repeatedly, so that a participant can sense the occurrence of some change, finding an increased winning probability. A combination of different facial expressions such as repeated switching between a laughing face and a crying face can also be possible.

In any case, the attention of a lottery participant to the main character is increased. Such changes in movement are suitable for the notification of a li-zhi state.

(3) The Shape of a Main Character is Changed.

It is also effective to change the shape of a main character into the shape of a prize to win in a li-zhi state at that time and return it to the original shape. Since the attention of a lottery participant to a main character in the image is great, a change of the shape can easily make the participant aware of the li-zhi state.

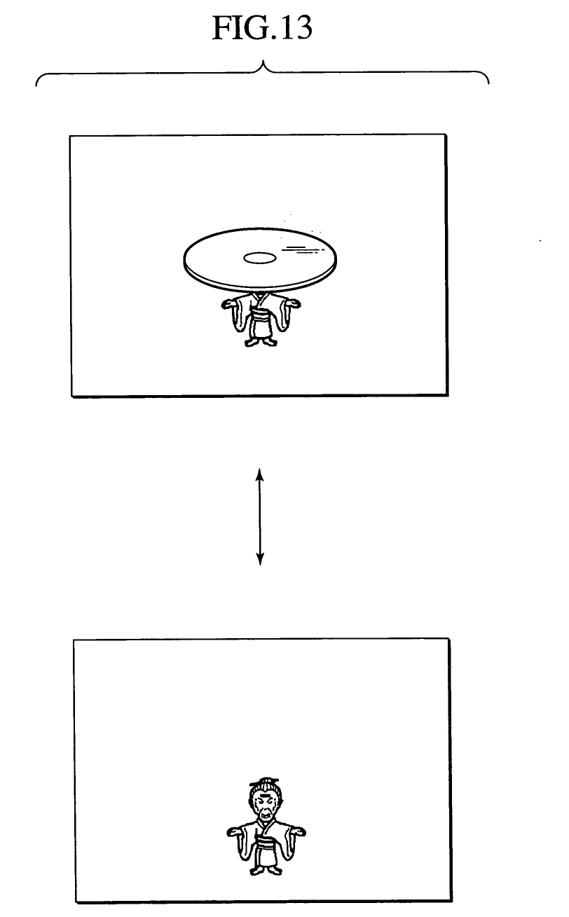

When the prize is a CD as shown in FIG. 13, for example, a head of a main character can be changed into an image of the CD and then returned to the original shape, so as to increase anticipation of winning the CD.

(4) A Character is Changed in Color.

Since the attention of a lottery participant to a main character is great, changing the color of the character into a predetermined color can be the notification of the fact that the winning probability is increased.

(5) Special Sound Effects are Generated.

The above is the case of using changes on the screen. It is also effective to generate special sound effects used only when there is a probability of win, for increasing a participant's anticipation. If it is combined with other changes on the screen, a participant will be more easily aware of it.

(6) A Dedicated Display Section Provided on the Margin or the Like is Used.

For example, development of a story and modification of a character are amusing, but lottery participants include all ages from children to elderly people. It is thus important that everyone can understand the content.

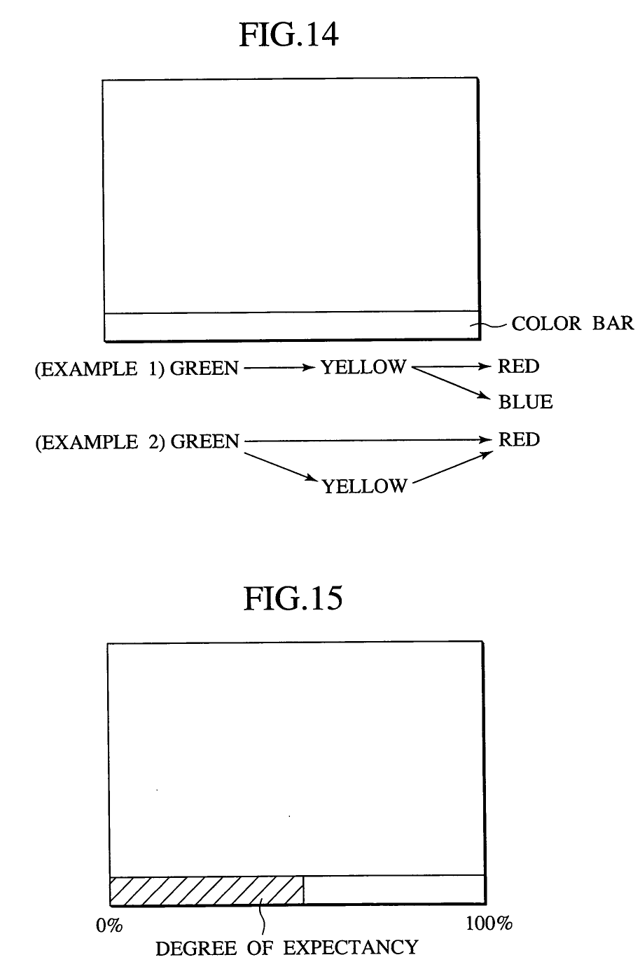

For that purpose, as shown in FIG. 14, for example, a display area (color bar in the figure) only for displaying winning probability is provided at the bottom of effect images in which a story is developed or on the margin. The color of the display can be changed in connection with the winning probability, so as to allow a participant to easily determine whether the state at that time is a li-zhi state or not.

In Example 1 in FIG. 14, an initial state is displayed in “green”, and through a state of “yellow” as a li-zhi state, a final state is displayed in one of different colors. Specifically, a win is displayed in “blue”, and a loss is displayed in “red”.

On the other hand, in Example 2 in FIG. 14, an initial state is displayed in “green”, and “yellow” is displayed only in a true li-zhi state. The preparation of the display mode only for the li-zhi state allows everyone to easily find that he or she is in a li-zhi state. Finally, “red” is displayed upon both a win and lose, showing that the result is decided. The displays in both Example 1 and Example 2 also have the purpose of notifying a participant of the degree of progress of a lottery.

As shown in FIG. 15, the degree of expectancy can be displayed with a bar graph in such a manner that when the degree of expectancy is increased, the bar is extended to the right in the figure, and when the degree of expectancy is reduced, the bar is shortened to the left in the figure, so that an increase in the degree of expectancy can be easily found. Needless to say, a combination of changes in the length of the bar and color is more effective. Instead of the bar graph, another display form such as a pie graph may be used.

<Advertising Function>

An effect image using the above functions attracts much attention and is visible to a lottery participant.

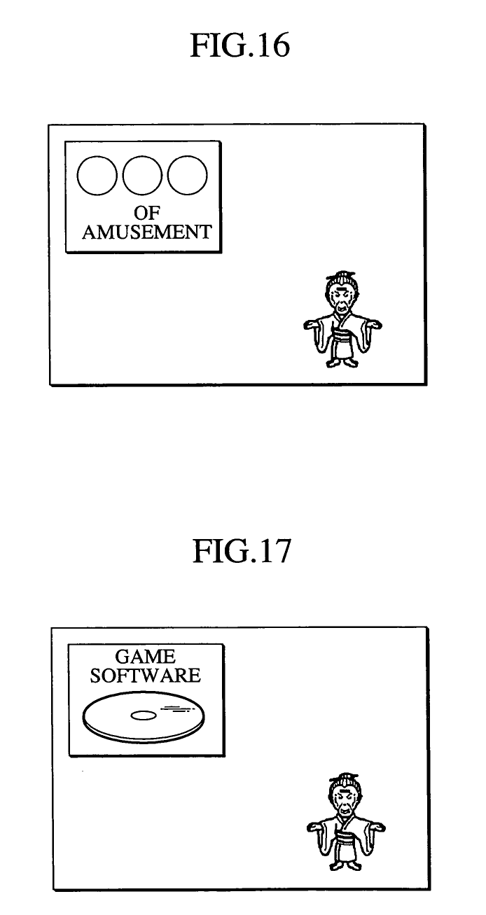

(1) Thus, this Characteristic can be Utilized to Provide a Function of Displaying an Advertisement of a Sponsor in an Effect Image as Shown in FIG. 16, Expecting a Great Advertising Effect.

In the case of FIG. 16, an advertisement is displayed as a back image. It is also possible to use a main character or another character of high visibility for an advertisement (to put clothes with an advertisement on a character or to switch the face of a character to an advertisement image), so as to obtain a great advertising effect.

It is also possible to bury an advertisement in a moving path of a main character so that the advertisement is displayed when the main character passes the point, drawing much attention of a lottery participant taken by surprise. In this case, a treasure hunt feature is added, providing the fun of looking for a buried advertisement.

(2) Although FIG. 16 shows an Advertisement of a Sponsor, it may Alternatively be Used for Advertising a Product to be Offered as a Prize.

For example, in order to advertise game software, the title of the game software, its package and the like can be displayed in the effect image as shown in FIG. 17, thereby attracting much attention of a lottery participant.

The advertisement of a prize can also be used for the notification of a li-zhi state. In the case where a story development can be changed according to the destination of movement of a character and the story development is allocated a specific prize, when the character stands at the entrance of the story development on a story development selection image, an advertisement of a prize to win when the story development is selected is displayed. In this manner, the advertisement of a product can be provided in response to the selection of the story development.

It is also possible to switch advertisements of prizes according to the moving direction of the character, thereby to notify a lottery participant which prize can be won at the destination in the moving direction, increasing the advertising effect. Alternatively, it is also possible to change the shape of the character into the shape of a product to be advertised.

(f) Shipment of Prize

The above operations are executed in real time through the Internet 1. On the other hand, the function of shipping prizes is for shipping a winning prize to a winner. A result of the lottery is registered by the server 3A in the personal information database 3C as personal data of the lottery participant.

The operator accesses the personal information database 3C, so as to search for cases requiring prize shipment. At the stage where a person in charge has shipped a prize, the completion of the shipment, the date of shipment and the like are registered in the corresponding section in the personal information database 3C, completing the series of operations.

(A-3) Concrete Example of Prize Offering Lottery

Now description will be made, using a concrete example, on effect images for use in the case where a roll-playing game feature is adopted for the notification of a lottery result. An imaginary prize-lottery system entitled “Haunted House (tentative title)” will be described.

Needless to say, this is only an example, and there are a variety of possible notification methods of increasing effects. Suppose that authentication and the like have already been executed using existing methods.

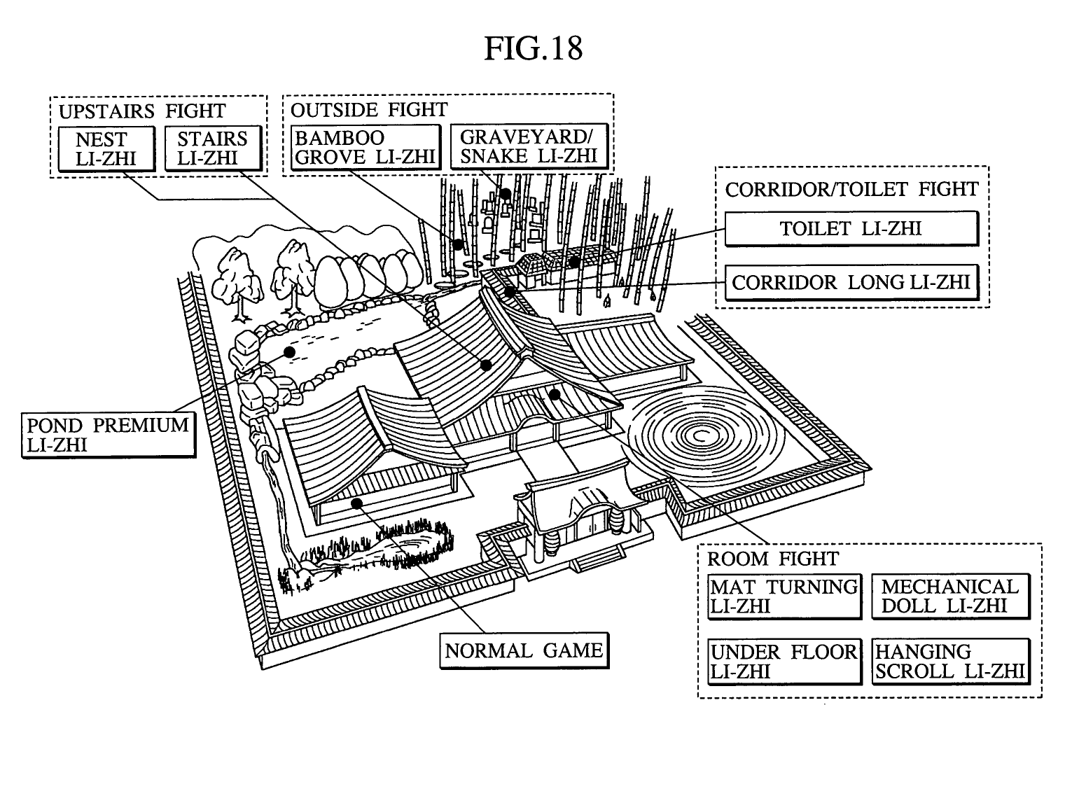

FIG. 18 is a panoramic view of a “haunted house” as the stage of effect images. In the prize-lottery system, six story developments are prepared for the notification of winning modes.

The six story developments are a “normal game”, a “room fight scene”, an “upstairs fight scene”, a “corridor/toilet fight scene”, an “outside fight scene”, and a “pond scene”. FIG. 18 shows connections between the story developments and scenes in which they are made (the locations of the stages).

The panoramic view is an initial effect image displayed. It depends on an operator's strategy whether or not to let a participant see which story development is associated with which location. In order to let a lottery participant select a story development, it is possible to let the participant make a selection from a list of story developments displayed on the image of the panoramic view. In this connection, it is possible to hide prepared li-zhi contents.

In the “haunted house”, the story development is fixed and a lottery participant cannot make a selection of the story development. That is, the story development is automatically executed based on a winning mode obtained as a result of the lottery.

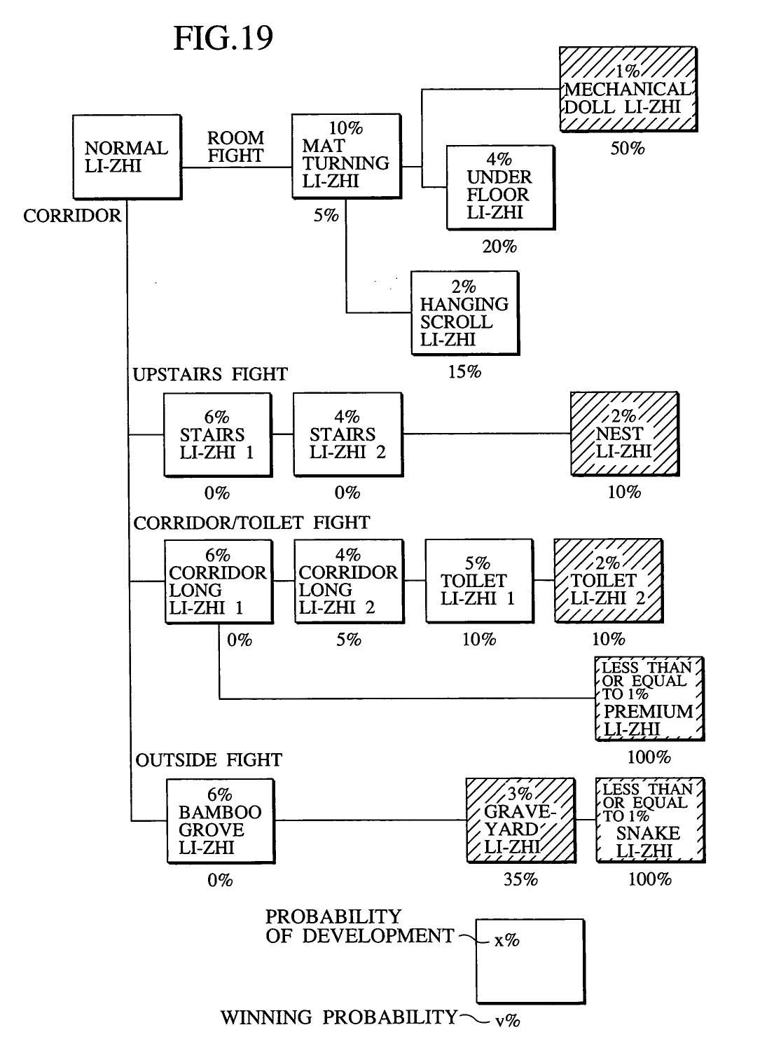

FIG. 19 illustrates the connection between the probability of development of each stage (li-zhi scene) constituting part of a story development and the probability of win at the stage. In FIG. 19, a percentage expression within a block designating a li-zhi state gives the probability of development from a previous stage, and a percentage expression below a block gives a winning probability at the stage.

Referring to FIG. 19, it is found that the “room fight scene” is developed from the “normal game” with a 10% probability, and a win is decided with a 5% probability in the first stage. Likewise, it is found that the “upstairs fight scene” is developed from the “normal game” with a 6% probability, but no win occurs in the first stage (a 0% winning probability). That is, a stage for increasing scenic effects is prepared. This is true for other stages with the expression of 0% in FIG. 19.

The “corridor/toilet fight scene” is also developed from the “normal game” with a 6% probability. In this case also, no win occurs in the first stage (a 0% winning probability). A “pond premium li-zhi scene” is hidden behind the “corridor/toilet fight scene”, and a scene of “corridor long li-zhi 1” develops into the “pond scene” with a probability of less than 1%. However, when it develops into the “pond scene”, a win occurs with a 100% probability.

The “outside fight scene” is also developed from the “normal game” with a 6% probability. No win occurs in the first stage (a 0% winning probability).

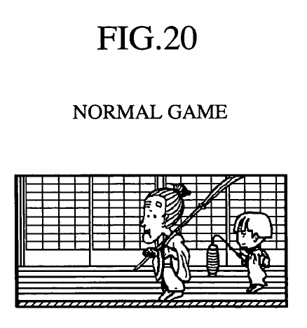

Now, description will be made on the effect content at each stage prepared for each story development. The “normal game” as a starting story has a corridor surrounding the house set as the stage. FIG. 20 shows an exemplary initial image. Characters are a grandma and a girl. The main character is the grandma. In this story development, three endings are prepared.

In a first ending, the grandma fails to fight off a first evil spirit and is ended up being counterattacked (a losing case). In a second ending, the grandma fights off first and second evil spirits to enter a normal li-zhi, and then fights off a third evil spirit in the end (a winning case). In a third ending, the grandma fights off first and second evil spirits to enter a normal li-zhi, but then fails to catch a third evil spirit (a case to develop into the next story).

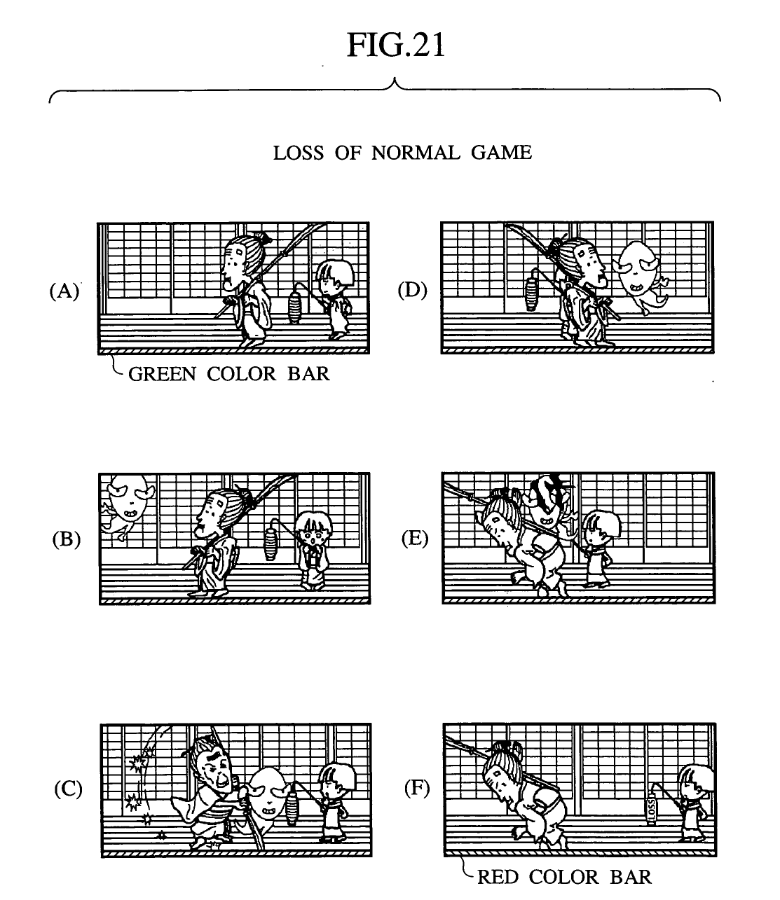

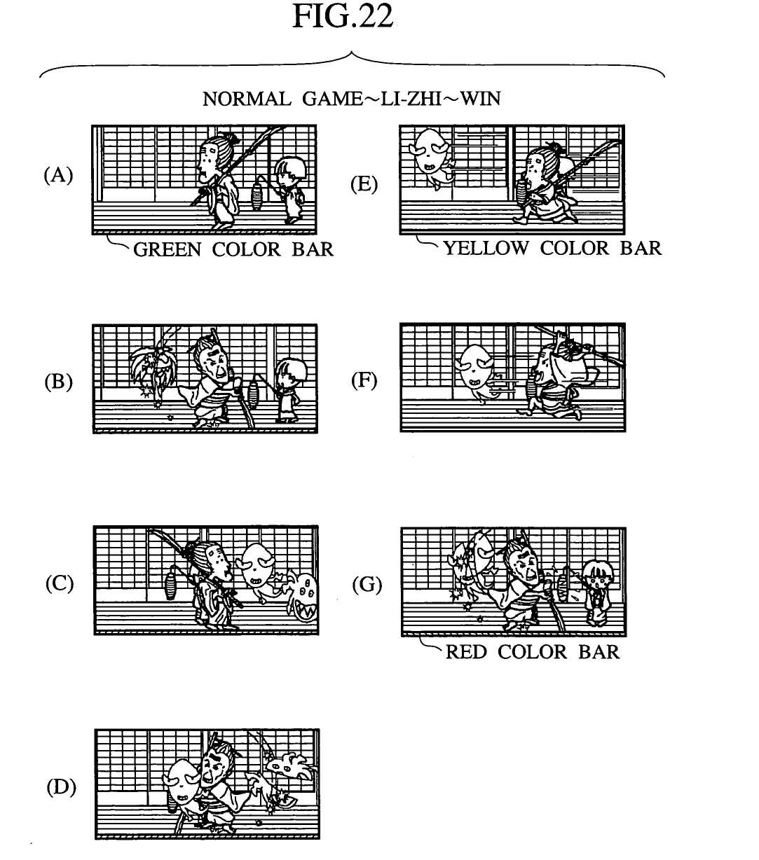

FIG. 21 shows an exemplary story development when the normal game is ended up being lost. FIG. 22 shows an exemplary story development when the normal game is ended up being won. In either exemplary development, a color bar is displayed below the image so that the development of the story and the occurrence of the li-zhi state are easily visible. The color bar is green in the initial state (FIGS. 21(A) and 22(A)). When the two characters start walking, effect display for notification of a winning mode is started. When the normal game is finished, the color bar on the image is turned red (FIGS. 21(F) and 22(G)).

At the same time, a lantern held by the girl is lighted and starts swinging, on the surface of which letters of “WIN” and “LOSS” are alternately seen off and on. The letters appearing on the surface of the lantern also function as an effect image for the notification of a winning mode. They are also used for notification when the result is decided (FIGS. 21(F) and 22(G)).

When the result of the lottery is loss, the story is developed as follows. First, a first evil spirit appears from the left (FIG. 21(B)), and the grandma swings a fauchard down (FIG. 21(C)). The evil spirit, however, wards off the fauchard, moving to the right (FIG. 21(D)). Thereafter, the evil spirit counterattacks (FIG. 21(E)), and the evil spirit goes away (FIG. 21(F)). At that time, the light of the lantern held by the girl goes out, the letters of the lantern becomes “LOSS”, and the loss is decided.

On the other hand, when the lottery result is a win in the normal mode, the story is developed as follows. First, a first evil spirit appears from the left, and the grandma cuts it down with the fauchard (FIG. 22(B)). The evil spirit disappears. Next, two evil spirits appear from the right (FIG. 22(C)). The grandma swings the fauchard down to get rid of one, but another one runs off (FIG. 22(D)). The cut evil spirit also disappears.

After that, the story moves to a li-zhi state (the color bar changes into yellow), and the grandma starts chasing after the evil spirit at a terrific speed (FIG. 22(E)). The grandma is gradually catching up with the evil spirit (FIG. 22(F)), and then cuts it down. The lantern is lighted brighter and the letters on the lantern are “WIN” and the win is decided (FIG. 22(G)).

In a case where a winning mode corresponds to the development into another story, the grandma fails to catch the evil spirit on the scene of FIG. 22(G), and the display of the story development is switched to a scene into which the evil spirit has disappeared. When probability of development is as shown in FIG. 19, it is most probable that the evil spirit runs into a “large room”. Its development probability is 10%. Into the “upstairs”, “corridor/toilet”, or “outside”, the evil spirit runs with a 6% probability.

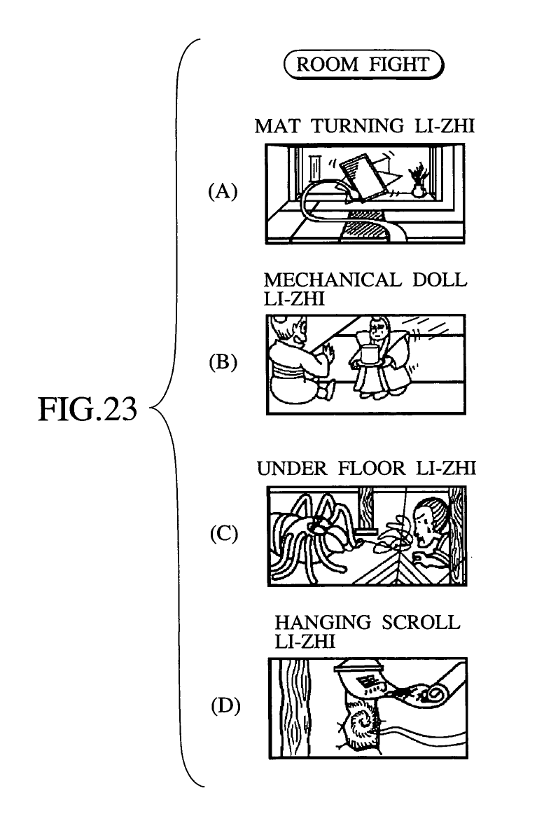

Here, the probability of running into the large room is the largest. The “room fight scene” has the large room on the first floor of the house set as the stage. In this story, “mat turning li-zhi”, “hanging scroll li-zhi”, “under floor li-zhi”, or “mechanical doll li-zhi” is prepared according to the degree of progress of the story (FIG. 23).

The “mat turning li-zhi” (FIG. 23(A)) appears first in the story. It is started when the grandma enters the large loom, running after the evil spirit. In this scene, a mat is flying in the air, and the evil spirit is running under the floor. If the grandma fights off the evil spirit before it disappears thereinto, a win is decided (a 5% winning probability). If the grandma bumps into the mat and the evil spirit runs off, a loss is decided.

However, the mat turning li-zhi is developed into the following “mechanical doll li-zhi” with a 1% development probability. If the grandma chases under the floor without bumping into the mat, the mat turning li-zhi is developed into the following “under floor li-zhi” with a 4% development probability.

When the mat turning li-zhi is developed into the “mechanical doll li-zhi” (FIG. 23(B)), a story follows in which a sliding door opens after the grandma bumps into the mat, and then a mechanical doll is coming for the grandma. If the grandma defeats the mechanical doll, a win is decided (a 50% winning probability), and if not, a loss is decided.

On the other hand, when the mat turning li-zhi is developed into the “under floor li-zhi” (FIG. 23(C)), a story follows in which the evil spirit transformed into a giant spider comes at the grandma. If the grandma gets rid of the giant spider, a win is decided (a 20% winning probability), and if not, a loss is decided.

In the large room, another place is prepared for the evil spirit to run into. It is the back of the hanging scroll. When the evil spirit chased by the grandma runs into the back of the hanging scroll, the mat turning li-zhi is developed into the “hanging scroll li-zhi” (FIG. 23(D)).

The probability of development from the “mat turning li-zhi” is 2%. The back of the hanging scroll constitutes another dimension in which they fight. If the grandma fights off the evil spirit, a win is decided (a 15% winning probability), and if not, a loss is decided.

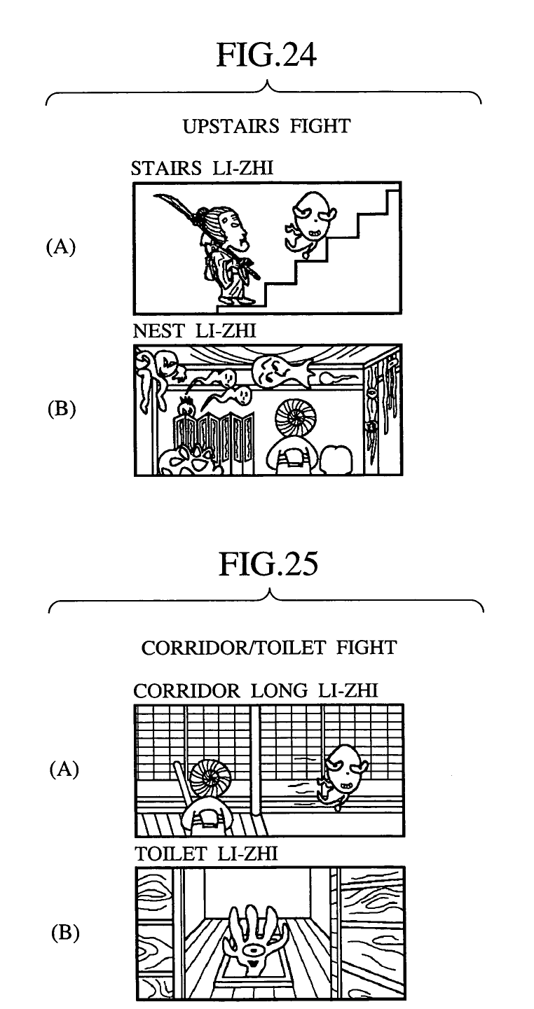

Now, a story development of the case where the evil spirit runs from a “gallery” into the “upstairs” will be described. In this story, two-stage “stairs li-zhi (li-zhi 1, li-zhi 2)” and “nest li-zhi” with a second-floor room as the stage (FIG. 24) are prepared.

The stairs li-zhi 1 and the stairs li-zhi 2 are different as to where the grandma reaches. When a loss is decided in the “stairs li-zhi 1”, the grandma slips off from a relatively low position of the stairs. When a loss is decided in the “stairs li-zhi 2”, the grandma is in a relatively high position of the stairs and almost reaches the top, but slips off therefrom.

Either li-zhi scene is an effect image with no winning probability (a 0% winning probability). Only 4% of lottery participants who clear the “stairs li-zhi 1” can reach the “stairs li-zhi 2”.

Only 2% of lottery participants who proceed to the “stairs li-zhi 2” can reach the “nest li-zhi” (FIG. 24(B)). It is supposed that the second floor is the nest of evil spirits, in which a fight between combined evil spirits and the grandma develops. If the grandma fights off the evil spirits, a win is decided (a 50% winning probability), and if not, a loss is decided.

On the other hand, when the evil spirit runs from the “gallery” into the “corridor/toilet”, the story develops as described below. In this story, two-stage “corridor long li-zhi (li-zhi 1, li-zhi 2)” and two-stage “toilet li-zhi (li-zhi 1, li-zhi 2)” are prepared (FIG. 25).

In the “corridor long li-zhi”, a scene in which the grandma chases after the evil spirit running along a long corridor extending to the toilet is produced. The grandma turns corners again and again to catch up with the evil spirit to get rid of it.

If the grandma loses track of the evil spirit at a corner, a loss is decided in the “corridor long li-zhi 1”. If the grandma does not negotiate a turn in the corridor and falls into a pond, it develops into the “pond premium li-zhi” and a win is decided. The probability of development from the “corridor long li-zhi 1” to the “pond premium li-zhi” is less than 1%, but the winning probability is 100%.

If the “corridor long li-zhi 1” is cleared with a 4% development probability, it moves to the “corridor long li-zhi 2”. In the “corridor long li-zhi 2”, the grandma is continuously chasing. If the grandma can catchup with the evil spirit and get rid of it, a win (a 5% winning probability) is decided. If the grandma loses track of the evil spirit, a loss is decided (FIG. 25(A)).

If the “corridor long li-zhi 2” is cleared at a development probability of 5%, it moves to the “toilet li-zhi 1”. In the “toilet li-zhi 1”, a battle between the evil spirit trying to run into the toilet and the grandma trying to get rid of the evil spirit is developed. If the grandma can intercept the evil spirit running into the toilet and get rid of it, a win is decided (a 10% winning probability). If the evil spirit managed to run into the toilet, a loss is decided. However, even when the evil spirit managed to get away, at a development probability of 2%, it moves from the “toilet li-zhi 1” to the “toilet li-zhi 2” (FIG. 25(B)).

In the “toilet li-zhi 2”, the evil spirit having run into the toilet appears in a different shape from a toilet bowl. If the grandma can get rid of the evil spirit (a 40% winning probability), a win is decided. If the grandma is dragged down into the toilet bowl, a loss is decided.

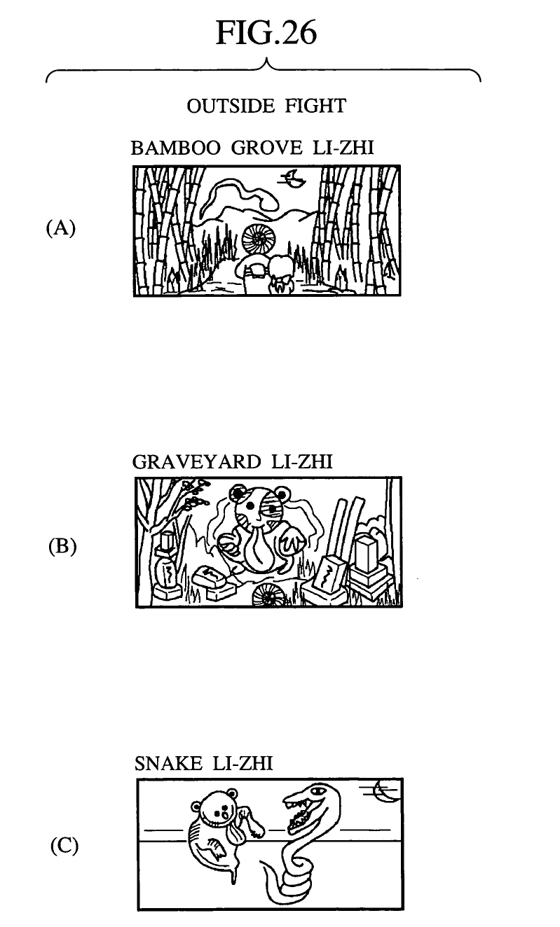

Finally, description will be made on the development of a story when the evil spirit runs from the “gallery” to the “outside”. In this story, “bamboo grove li-zhi”, “graveyard li-zhi”, and “snake li-zhi” are prepared (FIG. 26).

In the “bamboo grove li-zhi” (FIG. 26(A)), a battle between the evil spirit trying to run into the bamboo grove and the grandma trying to get rid of the evil spirit is developed. If the evil spirit managed to run into the bamboo grove, a loss is decided. In the “bamboo grove li-zhi”, there is no winning probability (a 0% winning probability).

If the grandma passes through the bamboo grove, running after the evil spirit trying to disappearing into the bamboo grove, it moves to the “graveyard li-zhi”. The probability of development is 3%. In the “graveyard li-zhi” (FIG. 26(B)), the evil spirit becomes monstrously large, coming at the grandma, and fighting with the grandma. If the grandma fights off the evil spirit (a 35% winning probability), a win is decided. If the grandma is swallowed by the evil spirit, a loss is decided.

However, even if the grandma is swallowed by the evil spirit, at a probability of less than 1%, it develops from the “graveyard li-zhi” to the “snake li-zhi”.

In the “snake li-zhi” (FIG. 26(C)), a “snake” crawling on the ground is transformed into a big snake, faces the evil spirit, and fights off the evil spirit. The grandma is rescued and a win is decided. The winning probability is 100%.

The preparation of the thrilling story developments enables many of lottery participants to get a lot of fun from effect images used in notification of a result of the lottery as well as having interests in the result. Also, the preparation of a number of li-zhi images directly irrespective of a win (a 0% winning probability) can provide effects such as to increase the degree of satisfaction of a lottery participant through a number of scenes even when the participant is losing.

Likewise, if a lottery participant can reach a scene of a very low probability of appearance while the final result is a loss, the participant can have a feeling that “I almost won” (the participant can have a sense of superiority more than in the case where he or she instantly knows the loss), and further, the participant can have a satisfaction with the fact that he or she can see a very rare scene (an active feeling of superiority).

As described above, according to the present invention, a prise-lottery system using a client terminal connected to the Internet as an input/output device for providing a prize offering lottery function to a qualified participant is equipped with a random number selection executing means for implementing random number processing based on information received from the client terminal and a winning mode notifying means for displaying effect images constituting a story on the client terminal based on a winning mode determined as a result of the random number selection processing, so that a lottery participant can enjoy the process of notification before a result of the lottery becomes clear.

Further, a lottery result managing means for storing information about a winning mode determined as a result of random number selection processing in association with information on a qualified participant is provided, so that information required for shipping a prize won as a result of the lottery can be collected, and also a past history of entering the lottery, a winning history and the like can be managed all together, enabling the collection of useful personal information.

The inclusion of special mode images indicating the probability of win as the effect images allows a lottery participant to more strongly anticipate a win, so as to make the process before the final decision of a win more enjoyable.

Even if a losing result of the lottery is decided, it is possible to leave an impression that it was almost won to make losing enjoyable.

Since only a single lottery operation is required before the final determination of a winning mode, a relatively small computer system can process a large number of lottery operations. Many of resources can be spared for processing of effect images, so as to increase effects.

The notification of a winning mode finally determined has no relation to the number of times of lottery operation, so that the notification method may be any. For example, if the number of times of the lottery operation is one, special mode images indicating the possibility of a win can be brought into sight several times in the effect images, so as to provide expectation for the notification of a result of the lottery.

It is also possible to set such that a lottery operation is required several times to finally determine a winning mode, and a winning operation at each time except one at the first time is executed during special mode images indicating the possibility of win are being displayed or immediately after the display, thereby to correspond to many winning modes even when the random number selection executing means has a small range of random number values. Unless the winning mode determined as a result of the lottery is a “loss”, another lottery operation can provide a lottery participant a chance of “winning some prize”.

Since a qualified participant can select a predetermined prize or prize group he or she wants before the execution of a lottery operation, a more user-friendly system enabling active participation in the lottery can be provided.

Thus, the needs of some qualified participants who do not want other prizes than those they want can be satisfied. It is not necessary to change winning probability when a prize or a prize group is specified, but it is possible to change it.

When there is a link between a specified prize and a story development, the same story development is repeated. In this case, however, it is also possible to eliminate the link with the story development.

Further, a qualified participant can select a range of story development of effect images before the execution of a lottery operation, thereby to be able to actively participate in the lottery, resulting in the provision of a more user-friendly system. In particular, the story development can be provided with depth to allow a qualified participant to have a fun of selecting a story development he or she does not know.

A qualified participant can select the direction of advancement of a character appearing in an effect image within the screen, so that a more user-friendly system enabling an active participation in the lottery can be provided.

It is possible to set such that a story development corresponding to a place within the image is started when a character moves to that place, so as to actively create a chance of getting a specific prize or prize group linked to the story development, and thereby to implement a highly amusing lottery system with a high rate of entry.

Further, an advertisement of a sponsor offering a prize can be displayed while an effect image is displayed, that is, a sponsor advertisement can be displayed within an effect image attracting much attention of a lottery participant, thereby to expect a higher advertising effect than before.

It is also possible to bury an advertisement in a path along which a character is movable to display the advertisement when the character passes through the place so as to add a treasure hunt feature.

An advertisement of a prize can be displayed while an effect image is displayed, that is, an advertisement of a prize can be displayed in an effect image attracting much attention of a lottery participant, thereby to expect a higher advertisement effect than before.

It is also possible to bury an advertisement in a path along which a character is movable to display the advertisement of a prize when the character passes through the place, thereby to add a treasure hunt feature with which a prize displayed can be won depending on the destination of movement of the character or a story development started thereafter.

The shape of a character can be changed into the shape of a prize according to a final winning mode, thereby to further increase a prize advertising effect with the transformation of the character watched by a lottery participant.

The shape, color and/or movement of a character can be changed according to a winning mode, thereby to further increase expectation for a result of the lottery with the change of the character watched by a lottery participant.

When a final winning mode is allocated several styles of or several kinds of prizes, a qualified participant can select a prize he or she wants before the execution of a lottery operation, or before the determination of a winning mode, or after the determination of a winning mode, thereby to fully satisfy even particular tastes of lottery participants with respect to the specifics of prizes.

A partial area of an effect image or a dedicated display area can be used to notify a qualified participant of the probability of win in stages, thereby to easily notify lottery participants of all ages of the probability of win.

Several-stage sound effects can be used to notify a qualified participant of the probability of win, thereby to easily notify lottery participants of all ages of the probability of win.

A qualified participant is sequentially notified of the remaining numbers of prizes to win to be able to predict a result to enter the lottery with conviction. Further, it is possible to preselect a prize or the like desired to perform a lottery of a higher winning probability, resulting in a lottery system capable of reflecting the intension of a qualified participant in a lottery operation.

A qualified participant can desirably select a main character to appear in effect images, so that an effect of causing the qualified participant to have a feeling of creating the effect images by himself or herself can be provided. Also, the qualified participant can have a feeling of leaving his or her win in charge of the selected main character, enjoying a feeling of active participation in the lottery at the same time. It is also possible to allow the ability, outfit or the like of the main character to be changed.

### INDUSTRIAL APPLICABILITY

As described above, the present invention can make lotteries via the Internet more attractive and amusing than before. In particular, the prize-lottery system can fully utilize the immediacy and interactivity of the Internet (e.g., in prize selection, story development selection, and main character selection), resulting in a more user-friendly and flexible lottery system.

1. A prize-lottery system for providing a prize offering lottery function to a qualified participant, by using a client terminal connected to the Internet as an input/output device, the prize-lottery system comprising:
a random number selection executing means for executing random number selection processing based on information received from the client terminal; and
a winning mode notifying means for causing the client terminal to display effect images constituting a story, based on a winning mode determined as a result of the random number selection processing.

2. The prize-lottery system as set forth in claim 1, further comprising a lottery result managing means for storing information about the winning mode determined as a result of the random number selection processing in association with information on the qualified participant.

3. The 1 prize-lottery system as set forth in claim 1, wherein the effect images include special mode images indicating a probability of winning.

4. The prize-lottery system as set forth in claim 2, wherein the effect images include special mode images indicating a probability of winning.

5. The prize-lottery system as set forth in claim 1, wherein a single lottery operation is required before a final winning mode is determined.

6. The prize-lottery system as set forth in claim 2, wherein a single lottery operation is required before a final winning mode is determined.

7. The prize-lottery system as set forth in claim 1, wherein multiple lottery operations are required before a final winning mode is determined, and each lottery operation except the first one is executed while special mode images indicating a probability of win are being displayed or immediately thereafter.

8. The prize-lottery system as set forth in claim 2, wherein multiple lottery operations are required before a final winning mode is determined, and each lottery operation except the first one is executed while special mode images indicating a probability of win are being displayed or immediately thereafter.

9. The prize-lottery system as set forth in claim 1, wherein the qualified participant can select a given prize or prize group the qualified participant wants, prior to execution of a lottery operation.

10. The prize-lottery system as set forth in claim 2, wherein the qualified participant can select a given prize or prize group the qualified participant wants, prior to execution of a lottery operation.

11. The prize-lottery system as set forth in claim 1, wherein the qualified participant can select a range of story development of effect images, prior to execution of a lottery operation.

12. The prize-lottery system as set forth in claim 2, wherein the qualified participant can select a range of story development of effect images, prior to execution of a lottery operation.

13. The prize-lottery system as set forth in claim 1, wherein the qualified participant can determine a moving direction of a character appearing in the effect images.

14. The prize-lottery system as set forth in claim 2, wherein the qualified participant can determine a moving direction of a character appearing in the effect images.

15. The prize-lottery system as set forth in claim 1, wherein an advertisement of a sponsor offering a prize is displayed while the effect images are being displayed.

16. The prize-lottery system as set forth in claim 2, wherein an advertisement of a sponsor offering a prize is displayed while the effect images are being displayed.

17. The prize-lottery system as set forth in claim 1, wherein an advertisement of a prize is displayed while the effect images are being displayed.

18. The prize-lottery system as set forth in claim 2, wherein an advertisement of a prize is displayed while the effect images are being displayed.

19. The prize-lottery system as set forth in claim 17, wherein the shape of a character is changed into the shape of the prize according to a final winning mode.

20. The prize-lottery system as set forth in claim 18, wherein the shape of a character is changed into the shape of the prize according to a final winning mode.

21. The prize-lottery system as set forth in claim 17, wherein the shape, color and/or movement of a character is changed according to a winning mode.

22. The prize-lottery system as set forth in claim 18, wherein the shape, color and/or movement of a character is changed according to a winning mode.

23. The prize-lottery system as set forth in claim 1, wherein, when a final winning mode is allocated multiple styles of or multiple kinds of prizes, the qualified participant is caused to select a prize the qualified participant wants, before execution of a lottery operation, or before determination of a winning mode, or after determination of a winning mode.

24. The prize-lottery system as set forth in claim 2, wherein, when a final winning mode is allocated multiple styles of or multiple kinds of prizes, the qualified participant is caused to select a prize the qualified participant wants, before execution of a lottery operation, or before determination of a winning mode, or after determination of a winning mode.

25. The prize-lottery system as set forth in claim 1, wherein a partial area of the effect images or a dedicated display area is used to notify the qualified participant of a probability of win in stages.

26. The prize-lottery system as set forth in claim 2, wherein a partial area of the effect images or a dedicated display area is used to notify the qualified participant of a probability of win in stages.

27. The prize-lottery system as set forth in claim 1, wherein multiple-stage sound effects are used to notify the qualified participant of a probability of winning.

28. The prize-lottery system as set forth in claim 2, wherein multiple-stage sound effects are used to notify the qualified participant of a probability of winning.

29. The prize-lottery system as set forth in claim 1, wherein the qualified participant is sequentially notified of the remaining number of a prize to win.

30. The prize-lottery system as set forth in claim 2, wherein the qualified participant is sequentially notified of the remaining number of a prize to win.

31. The prize-lottery system as set forth in claim 1, wherein the qualified participant can select a main character to appear in the effect images at will.

32. The prize-lottery system as set forth in claim 2, wherein the qualified participant can select a main character to appear in the effect images at will.
